(19) United States
(12) Patent Application Publication
(10) Pub. No.: US 2026/0210512 A1
(43) Pub. Date: Jul. 23, 2026

(54) LIGHTING DEVICE FOR A MOTOR VEHICLE

(71) Applicant: VALEO VISION, Bobigny (FR)

(72) Inventors: Yves GROMFELD, Bobigny (FR); Sergio DONOSO, Bobigny (FR); Carlos-Rafael MARCOS, Bobigny (FR)

(73) Assignee: VALEO VISION, Bobigny (FR)

(21) Appl. No.: 19/140,708

(22) PCT Filed: Dec. 19, 2023
(86) PCT No.: PCT/EP2023/086642

§ 371 Date: Jun. 18, 2025

(30) Foreign Application Priority Data
Dec. 22, 2022 (FR) FR2214355
Feb. 22, 2023 (FR) FR2301615

(51) Int. Cl. F21S 41/33

(52) U.S. Cl. CPC F21S 41/33

(57) ABSTRACT

The invention relates to a lighting device comprising a set of light sources (1), a first row of light sources (2), a first reflecting surface (6), a second reflecting surface (7) and
a primary lens (3). The first entrance dioptric interface (4) and the second entrance dioptric interface (5) are configured to receive light rays coming respectively from the set of light sources and from the first row of light sources. The exit dioptric interface (12) is configured to transmit light rays coming from the first row of light sources after they have been transmitted by the second entrance dioptric interface. The first reflecting surface is configured to reflect, toward the second reflecting surface, light rays coming from the set of light sources after they have been transmitted by the first entrance dioptric interface. These rays are then reflected on the second reflecting surface in order to be directed toward the exit dioptric interface.

### TECHNICAL FIELD

The present invention relates to the field of lighting, which includes signaling, and the members, in particular optical members, that con-tribute thereto. It is particularly advantageously applicable to the field of automotive vehicles. It relates in particular to a lighting device.

### BACKGROUND OF THE INVENTION

In the automotive sector, devices capable of emitting light beams, also referred to as lighting and/or signaling functions, are known.

These devices must comply with the regulations in force by emitting light in the desired locations while limiting the illumination in certain zones. One of the constraints also facing manufacturers is that of reducing the footprint of the device, in order to produce a device that is easier to use.

One technical solution for achieving these different objectives as far as possible is proposed in document FR3077362 A1. This solution is based on the development of a headlamp provided with three beams, so as to form a low beam associated with a supplementary high beam that makes it possible to obtain the desired light distribution. The distinctive feature of this solution lies in the fact that the near-field beam of a low beam light passes through a wave guide in which it undergoes several internal reflections that make it possible to direct the light beam to the desired positions.

However, this type of solution has drawbacks, in particular in that it is impaired by the number of optical elements required and therefore by the footprint of the device.

One object of the present invention is therefore to propose a device that makes it possible to at least partially overcome the aforementioned drawback.

The other objects, features and advantages of the present invention will become apparent upon studying the following description and the accompanying drawings. It will be understood that other advantages may be incorporated.

### SUMMARY OF THE INVENTION

To achieve this objective, according to one embodiment, a lighting de-vice is provided comprising:
a set of light sources,
a first row of light sources comprising light sources aligned in a first direction,
a primary lens comprising a first entrance dioptric interface, a second entrance dioptric interface, and an exit dioptric interface, the first entrance dioptric interface being configured to receive light rays coming from the set of light sources, the second entrance dioptric interface being configured to receive light rays coming from the first row of light sources, and the exit dioptric interface being configured to transmit light rays coming from the first row of light sources after they have been transmitted into the primary lens from the second entrance dioptric interface,
an optical axis and a first plane, the first plane being defined so that it contains the first direction d and is perpendicular to the optical axis,
a first reflecting surface and a second reflecting surface, the first reflecting surface being configured to reflect, toward the second reflecting surface, light rays coming from the set of light sources after they have been transmitted into the primary lens from the first entrance dioptric interface,

characterized in that the second reflecting surface is configured to reflect, toward the exit dioptric interface, the light rays coming from the set of light sources after they have been reflected on the first reflecting surface.

Given the positioning of the reflecting surfaces on the path of the light rays of the first beam, the first beam and the second beam produced thus share one and the same exit dioptric interface (for the primary lens), which consequently reduces the number of optics required for this device.

In addition, this configuration allows a specific location of the light out-put of the beams to be produced, in particular creating, in the primary lens, a common zone through which the rays pass for the cut-off beam and the supplementary high beam.

Likewise, the fact that the lighting device requires the use of a single exit dioptric interface for the primary lens makes it possible to eliminate the losses of illumination resulting from the difficulties of achieving alignment of the different optical elements of the device and coordinating the separate adjustment of two exit dioptric interfaces.

Another aspect relates to a vehicle provided with at least one lighting device.

### BRIEF DESCRIPTION OF THE DRAWINGS

The aims, objects, features, and advantages of the invention will be-come more clearly apparent on reading the detailed description of an embodiment thereof, illustrated by the following accompanying drawings, in which:

FIG. 1 shows a cross-sectional view along the second plane p2 of the lighting device according to the invention.

FIG. 2 shows a particular embodiment of the invention in which the second entrance dioptric interface is inclined.

FIG. 3 shows a configuration of the first reflecting surface according to a particular embodiment, together with the arrangement thereof relative to the set of light sources and to the collimators in a plane perpendicular to the second plane p2 passing through the first reflecting surface.

The drawings are given by way of example and do not limit the invention. They are schematic conceptual depictions intended to facilitate understanding of the invention and are not necessarily drawn to the scale of practical applications.

### DETAILED DESCRIPTION OF THE INVENTION

Before entering into a detailed review of embodiments of the invention, optional features that can be used in combination or as alternatives are described below:

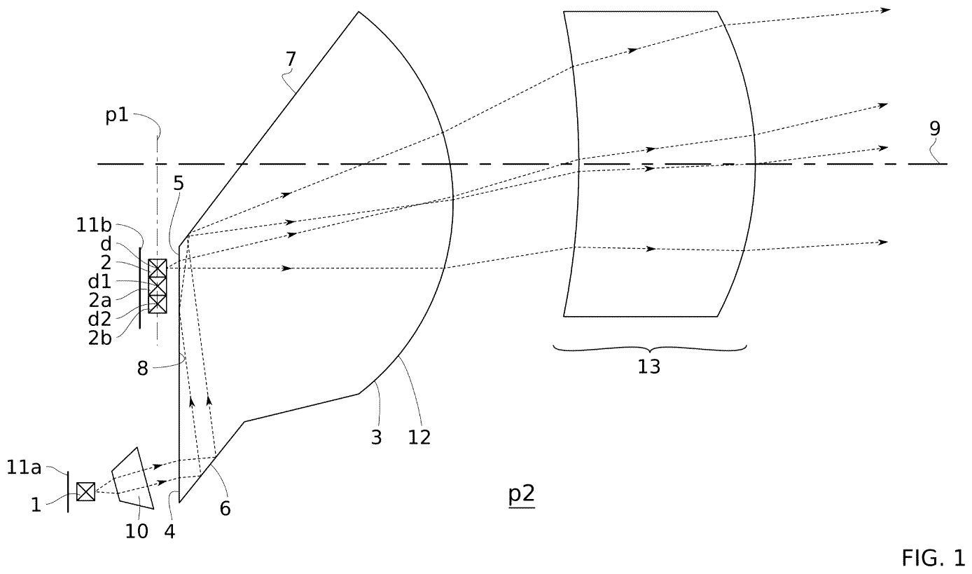

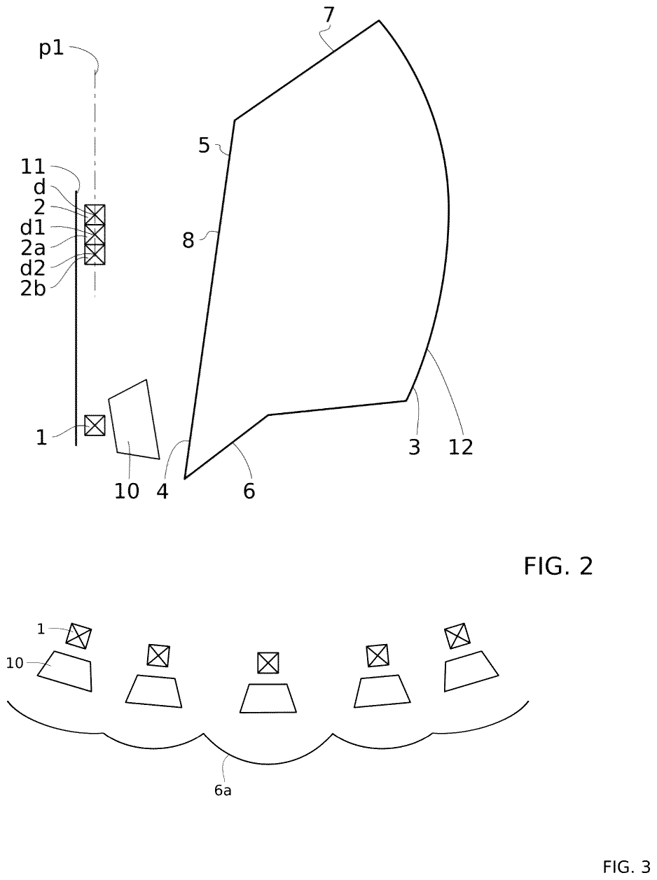

According to one example, as seen in FIG. 1 and FIG. 2, the lighting device comprises a third reflecting surface 8, the third reflecting surface 8 being configured so that the light rays coming from the set of light sources 1 are reflected on the third reflecting surface 8 after they have been reflected on the first reflecting surface 6 and before they are reflected on the second reflecting surface 7.

The arrangement of this third reflecting surface 8 makes it possible, with a bending effect, to include the maximum number of light rays coming from the set of light sources 1 within the final resulting lighting.

The positioning of this third reflecting surface 8 makes it possible to obtain lighting (after passing through the two lenses) in a zone positioned higher up than the lighting obtained by virtue of the light rays that are reflected solely on the second reflecting surface 7.

According to one example, the third reflecting surface 8 is at least partially formed by the second entrance dioptric interface 5.

By virtue of this configuration, the third reflecting surface 8 and the second entrance dioptric interface 5 are on the same plane, thus causing the light rays to be reflected on the second reflecting surface 7 after they have been reflected on the third reflecting surface 8. This configuration also makes it possible to simplify the lighting device.

According to one example, the second entrance dioptric interface 5 is inclined relative to the first plane p1.

This configuration makes it possible to obtain illumination distributions that are different and in particular oriented higher up or lower down in the lit central zone.

According to one example, the second entrance dioptric interface 5 is inclined relative to the first plane p1 by an angle of between 0 and 10° so that the angle between the first reflecting surface 6 and the third reflecting surface 8 is less than the angle between the first reflecting surface 6 and the first plane p1.

This configuration makes it possible to obtain a good compromise be-tween a desired illumination distribution and sufficient luminance. In addition, the value of this inclination is determined so as to obtain the desired efficacy for the light rays coming from the light sources of the set of light sources 1.

According to one example, as seen in FIG. 3, the first reflecting surface 6 comprises, for each light source of the set of light sources 1, a reflecting sub-surface 6a having a concave profile so that it directs light rays coming from the set of light sources 1 toward the second reflecting surface 7 and light rays coming from the set of light sources 1 toward the third reflecting surface 8, the reflecting sub-surfaces 6a being adjacent and having a first plane parallel to the plane p1 passing through them.

Through this configuration, the light rays coming from each light source of the set of light sources 1 will be oriented toward a reflecting sub-surface 6a. A minimal number of light rays will thus not be intercepted by the first reflecting surface 6, and therefore a minimal number of light rays will be unable to contribute to the lighting function.

The concave profile of the reflecting sub-surfaces 6a makes it possible to obtain, for each reflecting subsurface, a localized concentration of light rays on the second reflecting surface 7 or the third reflecting sur-face 8. The distribution of the light rays intercepting the second reflecting surface 7 and the third reflecting surface 8 after they have been reflected on the first reflecting surface 6 is more uniform than if the first reflecting surface 6 was made up of a single concave element. Com-pared to a situation in which the reflective sub-surfaces 6a were planar, the fact that the reflecting sub-surfaces are concave makes it possible to limit the number of light rays that do not contribute to the lighting function. The convergence of the rays toward the top of the lens 3 (and in particular toward the reflecting surface 7) is improved.

According to one example, the second reflecting surface 7 has a con-cave profile in a plane defined so that it directs the light rays coming from the set of light sources 1 toward the exit dioptric interface 12.

This configuration allows the light rays, after they have intercepted the second reflecting surface 7, to converge toward the exit dioptric interface 12, so that the light rays contribute to the lighting function as de-sired and are not excluded therefrom.

According to one example, the lighting device comprises a second plane p2, the second plane p2 being defined so that it contains the optical axis 9 and is perpendicular to the first direction d, the second reflecting surface 7 having a concave profile in the second plane p2.

The fact that the second reflecting surface 7 has a concave profile in the plane p2 makes it possible to limit geometric aberrations.

According to one example, the lighting device comprises a second row of light sources 2a comprising light sources aligned in a second direction d1 and a third row of light sources 2b comprising light sources aligned in a third direction d2, the second direction d1 and the third direction d2 being parallel to the first direction d, the second row of light sources 2a being positioned in contact with the first row of light sources 2 and the third row of light sources 2b being positioned in con-tact with the second row of light sources 2a.

The positioning of the second row of light sources 2a and the third row of light sources 2b makes it possible to obtain greater lighting and in particular lighting that extends higher up in the central zone to be lit.

According to one example, the first row of light sources 2, the second row of light sources 2a, and the third row of light sources 2b are configured to form or contribute to the formation of a supplementary high beam.

According to one example, the set of light sources 1 is configured to form a cut-off beam of a low beam light.

According to one example, the lighting device comprises collimators 10, each collimator 10 being associated with a separate light source of the set of light sources 1, each collimator 10 receiving light from said source and sending it, collimated, toward the first entrance dioptric interface 4.

Positioning a collimator associated with each light source of the set of light sources 1 makes it possible to obtain a collimated beam individually for each light source of the set of light sources 1, that is, a beam made up of parallel light rays. Due to their direction of intersection with the first entrance dioptric interface 4, this configuration makes it possible to better control the path of these light rays to the exit of the lighting device.

According to one example, the collimators 10 are oriented toward the first reflecting surface 6 with their exit face directed toward the second reflecting surface 7, an axis perpendicular to their exit face forming an angle of between 0° and 30° with the optical axis 9.

This configuration makes it possible to better orient the light rays coming from the set of light sources 1 so that these light rays (particularly those that enter toward the bottom of the lens), after they have intercepted the first reflecting surface 6, are directed toward a zone situated on the third reflecting surface 8 and on the part of the second reflecting surface 7 situated toward the third reflecting surface 8.

According to one example, the lighting device comprises a planar sup-port 11, the set of light sources 1 and the first row of light sources 2 being fastened to the support 11, the support 11 forming an angle equal to 90°±25° with the optical axis 9.

Due to the inclination of the support 11 relative to the optical axis 9, this configuration makes it possible to obtain different lighting levels that are distributed higher up or lower down in the central zone to be lit.

According to one example, the lighting device comprises a first support 11a and a second support 11b, the first support 11a being perpendicular to the optical axis 9 and parallel to the second support 11b, the set of light sources 1 being fastened to the first support 11a and the first row of light sources 2, the second row of light sources 2a, and the third row of light sources 2b being fastened to the second support 11b.

The support or supports 11, 11a, 11b are typically printed circuit boards comprising electrical and electronic controls for controlling the sources.

The positioning of a separate support for the set of light sources 1 and for the first row of light sources 2, the second row of light sources 2a, and the third row of light sources 2b, makes it possible to provide a wide range of possible configurations for the inclination of the light sources in question. The set of light sources 1 and the first row of light sources 2, the second row of light sources 2a, and the third row of light sources 2b, can be inclined at different inclinations relative to the optical axis 9.

According to one example, the lighting device comprises a projection lens 13 positioned on the optical axis 9 after the primary lens 3.

Associating a primary lens with a projection lens thus makes it possible to obtain the desired distribution of the light along a plane perpendicular to the optical axis 9 while having sufficient lighting power and imaging quality.

This configuration makes it possible to control the distribution of the illumination at the exit of the lighting device, in particular having a symmetrical distribution of the illumination relative to the plane p2.

In the features disclosed herein, the terms relating to the vertical, horizontal, or transverse (or lateral) directions, or equivalents thereof, are given to be relative to the position in which the lighting system is in-tended to be mounted in a vehicle. The terms “vertical” and “horizontal” are used in the present description to denote directions in an orientation perpendicular to the horizontal plane for the term “vertical” (which corresponds to the height of the systems), and in an orientation parallel to the horizontal plane for the term “horizontal”. They should be considered in operating conditions of the device in a vehicle. The use of these words does not mean that slight variations about the vertical and horizontal directions are excluded from the invention. For example, an inclination relative to these directions of the order of +or −10° is considered here to be a minor variation about the two preferred directions. With respect to the horizontal plane, the inclination is in principle between −5° and +4°, and it is between −6° and +7.5° laterally.

In the context of the present description, the adjectives “lower” and “upper” and their equivalents (under, below, on, above) are given with respect to the vertical direction, that is the direction perpendicular to the first direction d and the optical axis 9. In the same context, an upper element is situated above (but not necessarily in contact with or directly in line with) a lower element, in the vertical direction.

The invention is not limited to the embodiments described above and extends to all the embodiments covered by the invention.

According to one embodiment, the lighting device comprises a set of light sources 1, a first row of light sources 2, a primary lens 3, a first reflecting surface 6, and a second reflecting surface 7. The first row of light sources 2 comprises light sources arranged on a straight line in the first direction d. The primary lens 3 comprises a first entrance dioptric interface 4, a second entrance dioptric interface 5, and an exit dioptric interface 12. The first entrance dioptric interface 4 is configured to transmit light rays coming from the set of light sources 1. The second entrance dioptric interface 5 is configured to transmit light rays coming from the first row of light sources 2. The exit dioptric interface 12 is configured so that the light rays coming from the first row of light sources 2 pass through it after they have been received by the second entrance dioptric interface 5 of the primary lens 3. The first plane p1 is defined so that it contains the first direction d and is perpendicular to the optical axis 9.

The first reflecting surface 6 is configured to reflect, toward the second reflecting surface 7, light rays coming from the set of light sources 1 after they have been received by the first entrance dioptric interface 4 of the primary lens 3.

The second reflecting 7 surface is configured to reflect, toward the exit dioptric interface 12, the light rays coming from the set of light sources 1 after they have been reflected on the first reflecting surface 6.

The exit dioptric interface 12 of the primary lens 3 can be distorted on the lower part thereof (that is, below the optical axis 9) so as to add volume to the beam coming from the first row of light sources 2, that is, so that it increases the width and the height of the beam in question. The exit dioptric interface 12 of the primary lens 3 can also be distorted on the upper part thereof (that is, above the optical axis 9) so as to improve the join between the beam coming from the first row of light sources 2 and the beam coming from the set of light sources 1.

Preferably, the lighting device comprises a third reflecting surface 8. Preferably, the third reflecting surface 8 is configured so that some of the light rays coming from the set of light sources 1 are reflected on the third reflecting surface 8 after they have been reflected by the first reflecting surface 6 and before they are reflected by the second reflecting surface 7.

Advantageously, the third reflecting surface 8 and the second entrance dioptric interface 5 are situated on one and the same surface, which is preferably planar. The third reflecting surface 8 is formed by part of the second entrance dioptric interface 5.

According to one option, the first row of light sources 2 can have, as the entrance dioptric interface into the primary lens, a zone comprising part of the second entrance dioptric interface 5 and part of the second reflecting surface 7 (to this end, the first row of light sources 2 can be translated in the vertical direction). This zone can thus be intercepted by light rays coming from the set of light sources 1 and from the first row of light sources 2. This results in an advantageous combination between the beam coming from the set of light sources 1 and the beam coming from the first row of light sources 2, and in particular after the exit dioptric interface of the projection lens 13. Preferably, the second entrance dioptric interface 5 and the second reflecting surface 7 can be joined by a ridge.

Preferably, the second entrance dioptric interface 5 is oriented relative to the first plane p1 so that together they form a non-zero angle.

In one preferred embodiment, the second entrance dioptric interface 5 is oriented relative to the first plane p1 so that together they form an angle of between 0 and 10° so as to reduce the value of the angle formed between the first reflecting surface 6 and the second entrance dioptric interface 5.

Preferably, the first reflecting surface 6 comprises a set of reflecting sub-surfaces 6a.

Each light source of the set of light sources 1 is associated with a reflecting sub-surface 6a. Each reflecting sub-surface 6ahas a concave profile so that it orients light rays coming from the set of light sources 1 toward the second reflecting surface 7 and light rays coming from the set of light sources 1 toward the third reflecting surface 8. The reflecting sub-surfaces 6a are positioned one next to the other and partially contained by a plane parallel to the plane p1.

The reflecting sub-surfaces 6acan be positioned so that the set of reflecting sub-surfaces 6adescribes a generally concave shape in the plane parallel to the plane p1 in which they are at least partially contained.

The reflecting sub-surfaces can therefore be staggered on either side of the reflecting sub-surface positioned in the center. This positioning is advantageously symmetrical along a vertical plane passing through the optical axis of the lens.

Advantageously, the second reflecting surface 7 has a concave profile in a plane defined so that it directs the light rays coming from the set of light sources 1 toward the exit dioptric interface 12.

In one advantageous embodiment, the lighting device comprises a second plane p2. The second plane p2 is defined so that it contains the optical axis 9 and is perpendicular to the first direction d. The second reflecting surface 7 has a concave profile in the second plane p2 so as to it limit geometric aberrations.

Preferably, the lighting device comprises a second row of light sources 2a and a third row of light sources 2b. The second row of light sources 2a comprises light sources arranged on a straight line in a second direction d1. The third row of light sources 2d comprises light sources arranged on a straight line in a third direction d2. The second direction d1 and the third direction d2 are parallel to the first direction d. The second row of light sources 2a is positioned in contact with the first row of light sources 2 and the third row of light sources 2b is positioned in contact with the second row of light sources 2a. The second row of light sources 2a and the third row of light sources 2b are positioned so that the light rays coming from these light sources are directed toward the second entrance dioptric interface 5.

According to one preferred embodiment, the first row of light sources 2, the second row of light sources 2a, and the third row of light sources 2b are configured to form or contribute to the formation of a supplementary high beam.

The invention can contribute to a high beam function, the function of which is to illuminate the scene in front of the vehicle over a wide area, but also over a substantial distance, typically approximately two hundred meters. This light beam, due to its lighting function, is mainly located above the horizon line. It can have a slightly upward optical lighting axis, for example. In particular, it can be used to generate a “supplementary” lighting function that forms a portion of a high beam light that supplements the portion produced by a near-field beam, the supplementary high beam seeking entirely, or at least mainly, to illuminate above the horizon line, whereas the near-field beam (which can have the specific features of a low beam light) seeks to illuminate entirely, or at least mainly, below the horizon line. The supplementary high beam can therefore be a main part of the overall “high” beam and be associated with another beam contributing to the low beam light.

The device can also be used to form other lighting functions via or apart from those described above in relation to adaptive beams. This makes it possible to produce a lighting matrix to selectively illuminate parts of the space in front of the vehicle.

Advantageously, the set of light sources 1 is configured to form a cut-off beam of a low beam light.

Preferably, the lighting device comprises collimators 10. Each collimator 10 is associated with a separate light source of the set of light sources 1. Each collimator 10 receives light from said source and sends it, collimated, toward the first entrance dioptric interface 4.

Preferably, the collimators 10 are oriented so that they direct the collimated light rays toward the first reflecting surface 6. More specifically, the exit face of the collimators 10 is oriented toward the second reflecting surface 7. Preferably, the longitudinal axis of symmetry of the collimators forms an angle of between 0° and 30° with the optical axis 9.

Advantageously, the lighting device comprises a planar support 11. The set of light sources 1 and the first row of light sources 2 are rigidly connected to the support 11. The support 11 is inclined relative to the optical axis 9 so that together they form an angle equal to 90°±25°.

Preferably, the lighting device comprises a first support 11a and a second support 11b. The first support 11a is perpendicular to the optical axis 9 and parallel to the second support 11b. The set of light sources 1 is rigidly connected to the first support 11a. The first row of light sources 2, the second row of light sources 2a, and the third row of light sources 2b are rigidly connected to the second support 11b. The second row of light sources 2a can be positioned under the first row of light sources 2. The third row of light sources 2b can be positioned un-der the second row of light sources 2a.

The first row of light sources 2, the second row of light sources 2a, and the third row of light sources 2b can be spaced apart from the primary lens 3 by a distance of 0.5 mm.

This distance is chosen as a function of the thermal resistance of the material of the primary lens 3, which is selected so as to minimize the distance between the light sources and the primary lens 3 as much as possible, in order to collect the maximum amount of light and therefore maximize efficiency.

The support 11a can be spaced apart from the support 11b by a distance of between 10 and 30 mm.

The supports 11, 11a, and 11b can be made from printed circuit boards (PCB). The light sources 1, 2, 2a, and 2b can be fastened to the supports by adhesive bonding or another type of fastening, for example by clips.

Preferably, the second entrance dioptric interface 5 is separated from the exit dioptric interface 12 by a distance greater than 30 mm. This distance is taken on the optical axis 9.

This configuration is selected so that a compromise is obtained be-tween a minimal footprint of the lighting device and an orientation of the light rays at the ends of the exit dioptric interface 12 that allows them to reach the projection lens 13.

The distance between the entrance dioptric interface and the exit dioptric interface of the projection lens 13 can be 25 mm.

The distance between the primary lens 3 and the projection lens 13 can be 7.5 mm.

Advantageously, the lighting device comprises a projection lens 13 positioned on the Preferably, the primary lens 3 and the projection lens 13 are made from PMMA (polymethyl methacrylate), silicone, glass, or PC (polycarbonate), which allows better thermal resistance than PMMA. The system comprising the primary lens 3 and the projection lens 13 can have a focal length of 44 mm. The geometric aperture of the primary lens 3 and of the projection lens 13 can be 30 mm by 60 mm.

Advantageously, the primary lens 3 and the projection lens 13 have a size of 30 by 60 mm (excluding fastening zones).

According to one advantageous embodiment, the optical axis 9 and the first direction d are orthogonal.

Preferably, all or only some of the light sources of the set of light sources 1, the first row of light sources 2, the second row of light sources 2a, and the third row of light sources 2b can be activated selectively, thus creating a pixelated light source.

The positioning of the light sources of the set of light sources 1 that can be switched on individually thus makes it possible to control the value of the illumination depending on the zone under consideration. The acronym ADB (for adaptive driving beam) is used for this type of function.

Selective activation of the light sources makes it possible to obtain varied light beam configurations that can be adapted to various situations. The zones that should be lit thus are, and those in which the illumination should be reduced due to regulatory requirements also are.

This discretization of the light is also referred to as a segmented beam. A beam, the projection of which forms an image composed of beam segments, each segment being able to be switched on independently, is thus referred to as a segmented beam.

Not all of the emissive elements are thus necessarily active, that is, emit light, simultaneously. This function allows the shape of the generated beam to be modulated. If a light source is not activated, its image, as projected by the optical device, will be absent. It then forms a lighting void in the resulting overall beam. This void is interrupted only by source-coupling effects and the effects of stray light from the optic.

The system according to the invention can comprise a unit for controlling the activation of each of the sources that is configured to produce at least one dark zone forming a tunnel in a projected beam by deactivating a group of adjacent sources, the control unit being configured to determine the number of sources of the group corresponding to the dark zone depending on the widthwise dimension of the sources.

The control unit can comprise a computer program product, preferably stored in a non-transitory memory, the computer program product comprising instructions that, when executed by a processor, determine the sources to be activated, in particular to obtain at least one dark zone (in which the sources are not activated) of defined surface area, taking into account the variable surface area of the images of the elements.

Advantageously, the LEDs of the whole of the lighting device 1, 2, 2a, and 2b have an emissive surface area of 0.5 mm2 or 1 mm2. The LEDs can have a height of 0.74 mm and a width of 1 mm. The size of the LEDs is directly linked to the desired beam volume. In addition, in order to have a large beam volume it is also possible to add further rows of LEDs.

Two consecutive light sources of the set of light sources 1, the first row of light sources 2, the second row of light sources 2a, and the third row of light sources 2b can be at a distance of 0.025 mm.

The rows of light sources 2, 2a, and 2b can be spaced apart from each other by a distance of 1.025 mm.

The rows of light sources 2, 2a, and 2b can be spaced apart from the set of light sources 1 by a distance of between 10 mm and 30 mm.

The first row of light sources 2 can be positioned at a distance of 1 mm from the second reflecting surface 7.

The light sources of the rows of light sources 2, 2a, and 2b can each be made up of 24 light sources. The light sources of the set of light sources 1 can be nine in number. The light sources of the set of light sources 1 can be nine in number.

The beam coming from the row of light sources 2 can illuminate over an angle of 30° (30° exterior and 12° interior). The beam coming from the set of light sources 1 can illuminate over an angle of 35°. The whole system allows a resolution of 1.5°, which is in particular as a result of the distance between two edges of two consecutive pixels (having an illuminance of 1 lux).

The conventional sources currently used in the automotive field are light-emitting diodes, also commonly referred to as LEDs, individually encapsulated in a housing. The light-emitting portion of the diode is covered by at least one light-transmissive layer, for example made from a transparent polymer material. Depending on the shape of the transmissive layer, it can be used as the primary optic as soon as light is generated in the diode. Such an LED thus forms a complex assembly combining an emissive portion and an optical portion. In addition, when these LEDs are arranged next to each other, the emissive portions of the adjacent LEDs are relatively far from each other, which re-quires optical projection designed not to image this spacing between the LEDs.

Advantageously, the light sources of the whole lighting device 1, 2, 2a, and 2b have a maximized emissive portion.

As a result, where several electroluminescent sources are used, the spatial resolution between these different sources is thus improved. Indeed, there is minimal space between the different light sources.

The emissive portion can be exposed at the end face of the source and occupies at least 90% of the surface area of said end face, preferably 98% and even more preferably 100% of the surface area. In the latter case, the emissive portion then forms the face by which the light exits the source.

These sources can in particular be provided with at least one chip using semiconductor technology and able to emit light. In addition, the expression light source is given here to mean a set of at least one elementary source able to produce a flux that causes at least one light beam to be output from the device of the invention.

Advantage is thus taken of this type of light source so that these sources can be arranged very close to one another (typically with a gap of less than 50 microns, or even less than 25 microns). Images can be formed directly from these sources. However, the efficiency of the optical device is maintained and the pixels are shaped, in particular vertically, by means of the primary optical element, which is an element common to the sources.

The source can be laterally delimited by several circumferential walls, which extend along the growth axis of the diode, and by an end face. The end face, in this case, comprises an emissive portion through which light is emitted when the diode is polarized.

The emissive portion can be either a layer, which can be referred to as an active layer, in which photon generation is carried out by electron-hole recombinations, or, more commonly, especially for white light, a conversion layer with charges, such as phosphor particles, allowing photons produced in the active layer to be re-emitted in a wavelength band adapted to the application.

In one advantageous embodiment, the end face of the source has a rectangular cross-section, which is typical for LED chips. The emissive portion thus also has a rectangular cross-section that is slightly smaller than the exit face. In particular, the length of one of the sides of the emissive portion is less than the length of one of the sides of the source end face by a value of between 10 micrometers and 40 micrometers. In other words, the distance between an edge of the end face and an edge of the emissive portion can be between 5 micrometers and 20 micrometers.

In the case of individually packaged light-emitting sources, also referred to as LED chips, the maximized size of the emissive portion results in a reduction in the size of the housing surrounding the light-emitting diode. Indeed, the housing can comprise edges that cover the circumferential walls of the diode. By having the emissive portion occupying almost all or all of the end face of the diode, these edges can be configured so that they have a very small thickness, for example of the order of a few micrometers. The housing surrounding the light-emitting diode is thus almost the same size as said diode. The housing is only a few micrometers larger than the end face of the diode.

In particular, sources sold under the brand name Luxeon NEO Exact® by Lumileds® can be used.

Another example of light sources with a maximized emissive portion are light sources comprising at least two rows of sources on a common substrate. This arrangement of elements can result from growth on the substrate from which they were respectively grown, or from any other production method, for example by transferring the elements using transfer techniques.

Various arrangements of electroluminescent elements can meet this definition of a monolithic array, provided that the electroluminescent elements have one of their main dimensions of elongation substantially perpendicular to a common substrate and that the transverse spacing between the pixels, formed by one or more electroluminescent elements grouped together electrically, is small in comparison with the spacings that are imposed in known arrangements of generally square flat chips soldered to a printed circuit board.

In other words, the invention can use a monolithic electroluminescent source that is divided into several individual segments. The individual segments are separated by a thin wall, for example made from silicone. The thickness of this thin wall is between 10 micrometers and 25 micrometers. In particular, sources sold under the brand name PixCell® by Samsung® can be used.

Advantageously, light sources that make it possible to form a near-field beam can be incorporated into the lighting device. This beam can also be referred to as a flat beam. It is projected entirely below the cut-off and serves to illuminate the near field in front of the vehicle. The beam coming from the set of light sources 1 makes it possible to define a cut-off zone. The combination of the near-field beam and the beam coming from the set of light sources 1 thus makes it possible to at least partially define a low beam.

This beam coming from the set of light sources 1 can therefore be con-figured to produce, in low-beam mode, a low beam portion that has a cut-off. The resulting angled portion is referred to as the low-beam “kink”.

Beams of the low beam light type typically have a first lateral zone (normally at the edge of the roadway) that projects at a slightly higher height than in a second lateral zone (normally at the center of the roadway), these two zones following one another laterally with the presence of a bend or kink between them.

A near-field beam of a low beam light is typically a projection that is relatively spread out laterally to the front of the vehicle, mainly or completely below the horizon line, generally seeking good distribution of the illumination over the entire lit zone.

Several lighting devices according to the invention can be arranged in a housing closed by an outer lens so as to obtain one or more lighting and/or signaling beams at the output of the headlamp. A headlamp can also be complex and combine a plurality of devices that can, furthermore, optionally share components.

### LIST OF REFERENCE SIGNS

1. set of light sources 2. first row of light sources
2a. second row of light sources
2b. third row of light sources
3. primary lens
4. first entrance dioptric interface
5. second entrance dioptric interface
6. first reflecting surface
6a. reflecting sub-surfaces
7. second reflecting surface
8. third reflecting surface
9. optical axis
10. collimators
11. support
11a. first support
11b. second support
12. exit dioptric interface
13. projection lens
p1. first plane
p2. second plane
d. first direction
d1. second direction
d2. third direction

What is claimed is:

1. A lighting device comprising:
a set of light sources,
a first row of light sources including light sources aligned in a first direction,
a primary lens including a first entrance dioptric interface, a second entrance dioptric interface, and an exit dioptric interface, the first entrance dioptric interface being configured to receive light rays coming from the set of light sources, the second entrance dioptric (interface being configured to receive light rays coming from the first row of light sources, and the exit dioptric interface being configured to transmit light rays coming from the first row of light sources after they have been transmitted into the primary lens from the second entrance dioptric interface,
an optical axis and a first plane, the first plane being defined so that the first plane contains the first direction and is perpendicular to the optical axis,
a first reflecting surface and a second reflecting surface, the first reflecting surface being configured to reflect, toward the second reflecting surface, light rays coming from the set of light sources after the light rays have been transmitted into the primary lens from the first entrance dioptric interface,
wherein the second reflecting surface is configured to reflect, toward the exit dioptric interface, the light rays coming from the set of light sources after the light rays have been reflected on the first reflecting surface.

2. The lighting device as claimed in claim 1, further comprising a third reflecting surface, the third reflecting surface being configured so that the light rays coming from the set of light sources are reflected on the third reflecting surface after the light rays have been reflected on the first reflecting surface and before the light rays are reflected on the second reflecting surface.

3. The lighting device as claimed in claim 2, wherein the third reflecting surface is at least partially formed by the second entrance dioptric interface.

4. The lighting device as claimed in claim 1, wherein the second entrance dioptric interface is inclined relative to the first plane.

5. The lighting device as claimed in claim 1, wherein the second entrance dioptric interface is inclined relative to the first plane by an angle of between 0 and 10° so that the angle between the first reflecting surface and the third reflecting surface is less than the angle between the first reflecting surface and the first plane.

6. The lighting device as claimed in claim 2, wherein the first reflecting surface includes, for each light source of the set of light sources, a reflecting sub-surface having a concave profile so that the reflecting sub-surface directs light rays coming from the set of light sources toward the second reflecting surface and light rays coming from the set of light sources toward the third reflecting surface, the reflecting sub-surfaces being adjacent and having a plane parallel to the first plane passing through the reflecting sub-surfaces.

7. The lighting device as claimed in claim 1, wherein the second reflecting surface has a concave profile in a plane defined so that the second reflecting surface directs the light rays coming from the set of light sources toward the exit dioptric interface.

8. The lighting device as claimed in claim 1, further comprising a second plane, the second plane being defined so that the second plane contains the optical axis and is perpendicular to the first direction, the second reflecting surface having a concave profile in the second plane.

9. The lighting device as claimed in claim 1, further comprising a second row of light sources including light sources aligned in a second direction and a third row of light sources including light sources aligned in a third direction, the second direction and the third direction being parallel to the first direction, the second row of light sources being positioned in contact with the first row of light sources and the third row of light sources being positioned in contact with the second row of light sources.

10. The lighting device as claimed in claim 2, wherein the first row of light sources, the second row of light sources, and the third row of light sources are configured to form or contribute to the formation of a supplementary high beam.

11. The lighting device as claimed claim 1, wherein the set of light sources is configured to form a cut-off beam of a low beam light.

12. The lighting device as claimed in claim 1, further comprising collimators, each collimator being associated with a separate light source of the set of light sources, each collimator receiving light from said the source and sending the light, collimated, toward the first entrance dioptric interface.

13. The lighting device as claimed in claim 12, wherein the collimators are oriented toward the first reflecting surface with an exit face directed toward the second reflecting surface, an axis perpendicular to their exit face forming an angle of between 0° and 30° with the optical axis.

14. The lighting device as claimed in claim 1, further comprising a planar support, the set of light sources and the first row of light sources being fastened to the support, the support forming an angle equal to 90°±25° with the optical axis.

15. The lighting device as claimed in claim 9, further comprising a first support and a second support, the first support being perpendicular to the optical axis and parallel to the second support, the set of light sources being fastened to the first support and the first row of light sources, the second row of light sources, and the third row of light sources being fastened to the second support.

16. The lighting device as claimed in claim 1, further comprising a projection lens positioned on the optical axis after the primary lens.
